(19) United States
(12) Patent Application Publication
(10) Pub. No.: US 2010/0006484 A1
(43) Pub. Date: Jan. 14, 2010

(54) Vehicle Water Flow Level System with Display and Memory Controllers

(76) Inventors: Charles Alvin Goodman, (US); Maxiann Theodora Moncur, (US)

Correspondence Address: Charles Goodman, Fox Hill Road, P.O. Box FH 14504, Nassau, BS

(21) Appl. No.: 12/498,361

(22) Filed: Jul. 6, 2009

Related U.S. Application Data
(60) Provisional application No. 61/079,081, filed on Jul. 8, 2008.

(51) Int. Cl. B01D 35/157

(52) U.S. Cl. 210/86

(57) ABSTRACT

A Vehicle Water Flow Level System with Display and Memory Controllers has an external unit with inner and outer chambers which can be easily attached to the exterior of the vehicle while the Display and Memory Controllers can be within the interior. The overall shape of the external unit can be vertical. The inner chamber can contain the float meter while the outer chamber can support the water flow meter at the bottom. Also at the bottom could be a screen adapter for a replaceable screen screw that acts as a filter, preventing debris from entering the inner chamber affecting the float meter. The controllers have a calibrating feature for adapting to various vehicle heights

### RELATED APPLICATIONS

The present application is a continuation application of U.S. provisional patent application, Ser. No. 61/079,081, filed Jul. 8, 2008, for VEHICLE WATER DEPTH DISPLAY SYSTEM, by Maxiann Moncur, Charles Goodman, included by reference herein and for which benefit of the priority date is hereby claimed.

### FIELD OF THE INVENTION

The present invention relates to a vehicle water flow level system and more particularly to a water flow level system with display and memory controllers to calibrate, record and display the levels and flow of water around a vehicle.

### BACKGROUND OF THE INVENTION

People today, especially drivers in automobiles and other vehicles pay more attention to safety because of increasing hazards on roads and highways. There are at times potholes, debris and numerous obstacles to avoid. Therefore various sensors, gauges and displays have been invented, produced and sold in the marketplace improving safety.

A broad-spectrum of indicators such as signals on external rear view mirrors, proximity alerts and tire pressure monitors are available so drivers may feel more secure.

Various types of liquid flow and level switches have been invented. Most of them are related to displaying the flow and level of water or fluid in a tank or contained environment. A vehicle water flow level system with display and memory controllers is perhaps non-existent.

It is therefore an object of the invention to provide a vehicle water flow level system.

It is another object of the invention to provide a vehicle water flow level system with display controllers.

It is another object of the invention to provide a vehicle water flow level system with memory controllers.

It is another object of the invention to provide a vehicle water flow level system with an inner chamber.

It is another object of the invention to provide a vehicle water flow level system with an outer chamber.

It is another object of the invention to provide a vehicle water flow level system with float switches.

It is another object of the invention to provide a vehicle water flow level system with flow switches.

It is another object of the invention to provide a vehicle water flow level display system with an overflow.

It is another object of the invention to provide a vehicle water flow level display system with a replaceable filter screw.

It is another object of the invention to provide a vehicle water flow level display system with a screw adapter for the replaceable filter screw.

### SUMMARY OF THE INVENTION

In accordance with the present invention, there is provided a vehicle water flow and level system with display and memory controllers; having an external unit that can be easily attached to the exterior of the vehicle and a display with memory controller panel installed on the interior. The overall shape of the external unit can be vertical with optional inner and outer chambers. The inner chamber can contain float switches while the outer chamber can support the water flow switch. Also at the very bottom could be a screen adapter supporting a replaceable filter screw to prevent debris from entering the inner chamber affecting the float switch and water readings. At the top could be an overflow allowing excess water to escape and air intake so the inner chamber remains primed to function properly. The display and memory controllers will afford precise real time readings of water levels based on its calibrating feature for adjusting to vehicle heights. The display and memory controllers would calibrate, record and interpret signals from the flow and level switches to display analog or digital the levels and speed water is moving around the vehicle. The present invention has arisen to mitigate or obviate the potential catastrophic situation that might occur for individuals in a vehicle experiencing harmful water flow levels. Some examples are stalling or being swept away by the flow rate of water.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a vehicle water flow level system with display and memory controllers showing overflow, float switch, outer chamber, flow switch, screw adapter, replaceable filter screw, display and memory controllers;

FIG. 2 is a side view of a vehicle water flow level system showing replaceable filter screw, float switch, inner chamber and outer chamber;

FIG. 3 is a top exploded view of vehicle water flow level display system showing outer chamber, inner chamber, float switch and replaceable filter screw;

FIG. 4 is a top sectional view of vehicle flow level system showing float switch and, overflow;

FIG. 5 is a bottom exploded view of a view of a vehicle flow level system showing inner chamber, float switch and screw adapter;

FIG. 6 is a bottom partial view of a vehicle flow level system showing filter in replaceable filter screw;

FIG. 7 is a bottom view of a vehicle flow level system showing replaceable filter screw, screw adapter and outer chamber;

FIG. 8 is a front view of a view of display controller with access memory; and

FIG. 9 is a flow chart view of a vehicle water flow level system with display and memory controllers showing overflow, float switch, outer chamber, flow switch, screw adapter, replaceable filter screw, display and memory controllers.

For purposes of clarity and brevity, like elements and components will bear the same designations and numbering throughout the Figures.

### DESCRIPTION OF THE PREFERRED EMBODIMENT

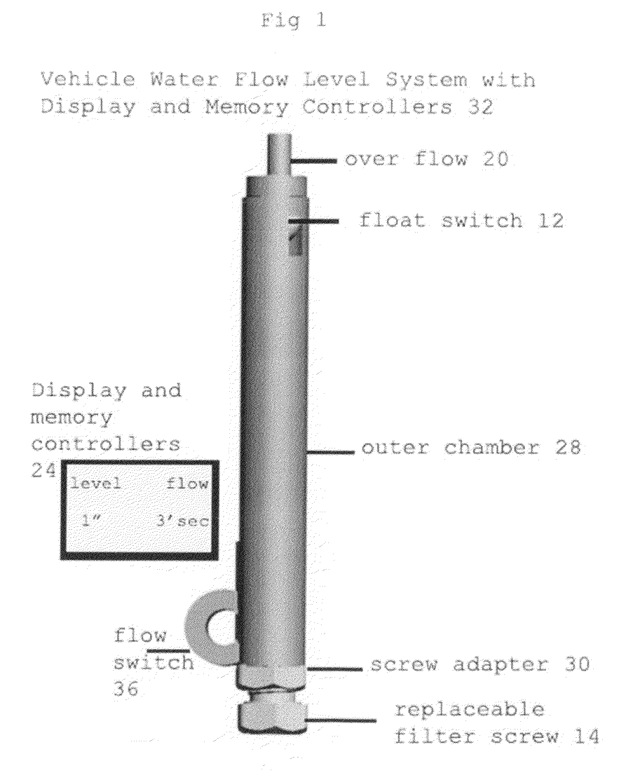

FIG. 1 is a perspective view of a Vehicle Water Flow Level System with Display and memory controllers 38 showing the outer chamber 28, overflow 20, level Float switch 12, and flow switch 36, screw adapter 30, replaceable filter screw 14, and Display and memory controllers 24 The outer chamber 28 can be metallic and heat resistant. The Float switch 12 can be paddle flow, RF capacitance level, magnetic, ultrasonic, and multi-level or any suitable level switch transmitter. The flow switch 36 could utilize the force of liquid to propel its paddle in order to detect the flow or moving water around the vehicle. The screw adapter 30 can be female adapter to accept the threaded replaceable filter screw 14. The replaceable filter screw 14 could be metallic with the center hollow so the screen like filter 34 can be placed to keep debris from entering the inner chamber 26. The Display and memory controllers 24 is an electronic device used to display water flow rate and levels. It also has a memory component to log float levels and flow rate for later retrieval. The controller unit would have a calibrating feature because vehicles have varying heights.

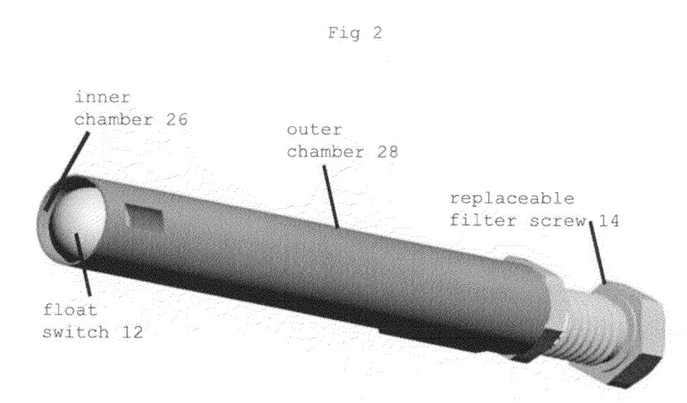

FIG. 2 is a side view of a Vehicle Water Flow Level System with Display and memory controllers 38 showing inner chamber 26, outer chamber 28, float switch 12, and replaceable filter screw 14.

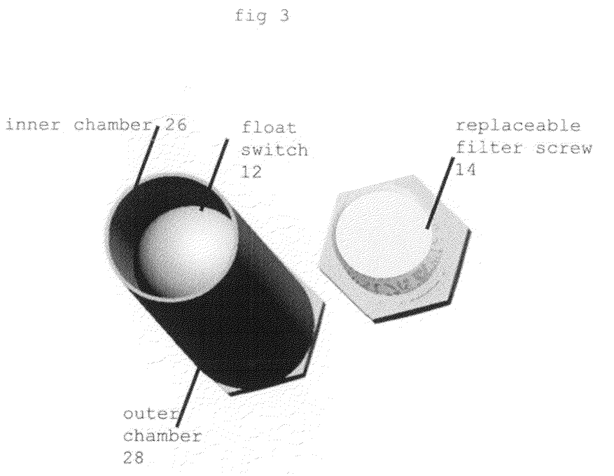

FIG. 3 is a top exploded view of a Vehicle Water Flow Level System showing outer chamber 28, inner chamber 26, float switch 12 and replaceable filter screw 14

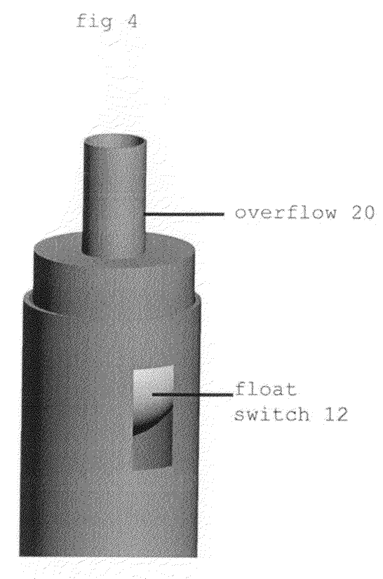

FIG. 4 is a top view of a Vehicle Water Flow Level System showing float switch 12, overflow 20.

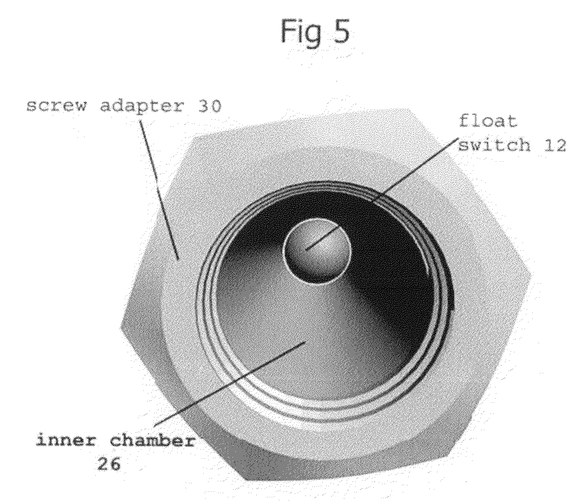

FIG. 5 is a bottom exploded view of a Vehicle Water Flow Level System showing inner chamber 26, float switch 12 and screw adapter 30.

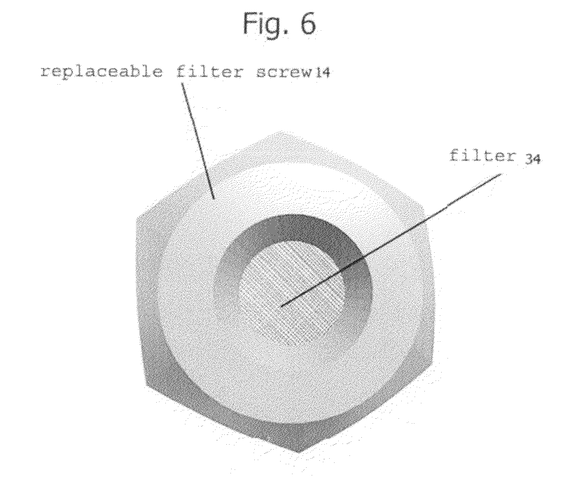

FIG. 6 is a bottom view of a Vehicle Water Flow Level System showing filter 34 in replaceable filter screw 14.

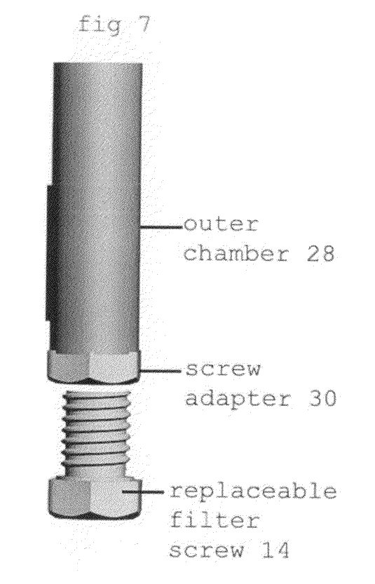

FIG. 7 is a bottom view of a Vehicle Water Flow Level System showing replaceable filter screw 14, screw adapter 30 and outer chamber 28

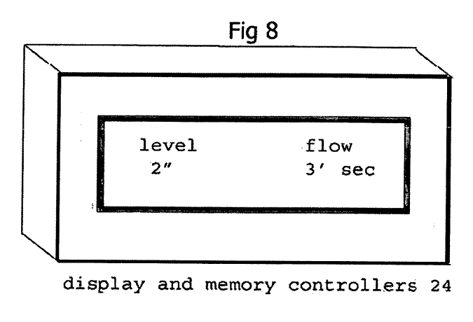

FIG. 8 is a front view of Display and Memory Controllers 24

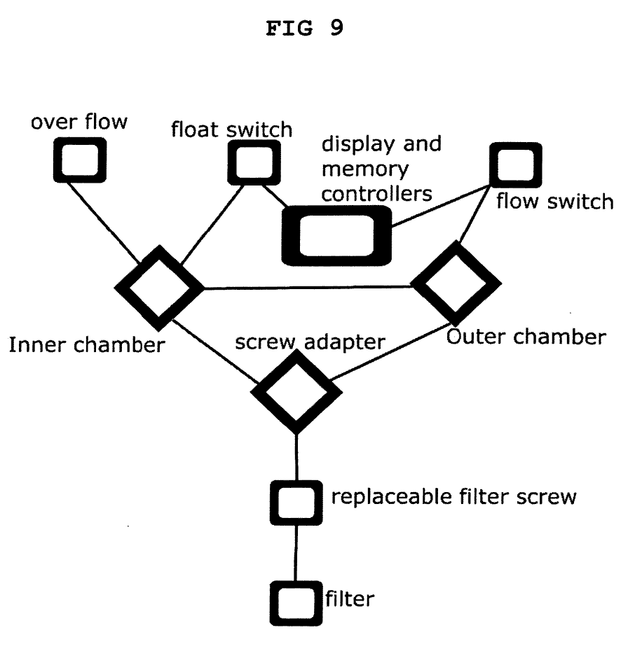

FIG. 9 is a flow chart view of the Vehicle Water Flow Level System with Display and memory controllers 38

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A vehicle water flow level system with display and memory controllers for monitoring, logging and displaying the level and flow of water around a vehicle, comprising: means for providing an outlet for excess water in chamber;
means for moving with the rise and fall of water in the chamber;
means for measuring the rate water is moving around the vehicle;
means for accepting the replaceable filter screw;
means for supporting the removable filter, removably fitted to said means for accepting the replaceable filter screw;
means for filtering so that only clear water enters the inner chamber, firmly fitted to said means for supporting the removable filter;
means for supporting the float switch, rigidly connected to said means for accepting the replaceable filter screw, moveably connected to said means for moving with the rise and fall of water in the chamber, and firmly secured to said means for providing an outlet for excess water in chamber;
and
means for recording, converting and displaying signals from the flow and level switches.

2. The vehicle water flow level system with display and memory controllers in accordance with claim 1, wherein said means for providing an outlet for excess water in chamber comprises an overflow.

3. The vehicle water flow level system with display and memory controllers in accordance with claim 1, wherein said means for moving with the rise and fall of water in the chamber comprises a float switch.

4. The vehicle water flow level system with display and memory controllers in accordance with claim 1, wherein said means for measuring the rate water is moving around the vehicle comprises a flow switch.

5. The vehicle water flow level system with display and memory controllers in accordance with claim 1, wherein said means for accepting the replaceable filter screw comprises a screw adapter.

6. The vehicle water flow level system with display and memory controllers in accordance with claim 1, wherein said means for supporting the removable filter comprises a replaceable filter screw.

7. The vehicle water flow level system with display and memory controllers in accordance with claim 1, wherein said means for filtering so that only clear water enters the inner chamber comprises a filter.

8. The vehicle water flow level system with display and memory controllers in accordance with claim 1, wherein said means for supporting the float switch comprises an inner chamber.

9. The vehicle water flow level system with display and memory controllers in accordance with claim 1, wherein said means for recording, converting and displaying signals from the flow and level switches comprises a display and memory controllers.

10. A vehicle water flow level system with display and memory controllers for monitoring, logging and displaying the level and flow of water around a vehicle, comprising:
an overflow for providing an outlet for excess water in chamber;
a float switch, for moving with the rise and fall of water in the chamber;
a flow switch, for measuring the rate water is moving around the vehicle;
a screw adapter, for accepting the replaceable filter screw;
a replaceable filter screw, for supporting the removable filter, removably fitted to said screw adapter;
a filter, for filtering so that only clear water enters the inner chamber, firmly fitted to said replaceable filter screw;
an inner chamber, for supporting the float switch, rigidly connected to said screw adapter, moveably connected to said float switch, and firmly secured to said overflow;
an outer chamber, rigidly connected to said inner chamber, rigidly connected to said screw adapter, and rigidly connected to said flow switch; and
a display and memory controller, for recording, converting and displaying signals from the flow and level switches.
